(19) United States
(12) Patent Application Publication
(10) Pub. No.: US 2011/0159843 A1
(43) Pub. Date: Jun. 30, 2011

(54) System and Method for Direct Device Activation

(76) Inventors: Darron Heath, Atlanta, GA (US); Feza Buyukdura, Fairview, TX (US); Steven Carlson, Atlanta, GA (US); William B. Chandler, JR., Snellville, GA (US); Cynthia Jackson, Powell, OH (US); Brian O'Rourke, Powell, OH (US); Sandra Spulecki, Dunwoody, GA (US); Narayanan Venkataraghavan, Norcross, GA (US)

(21) Appl. No.: 12/647,909

(22) Filed: Dec. 28, 2009

(51) Int. Cl. H04M 3/00; H04M 1/66; H04B 1/38

(52) U.S. Cl. 455/411; 455/418; 455/558

(57) ABSTRACT

Described herein are systems and methods for single-step direct activation of telecommunication services for a mobile device. One embodiment of the disclosure of this application is related to a system comprising a transceiver receiving product information from a mobile device and receiving service plan information from the mobile device, and a server verifying availability of service for the mobile device based on at least one of the product information and the service plan information, and activating telecommunication service with the mobile device. The received product information including an international mobile equipment identity (“IMEI”) number received from an IMEI trigger event and an international mobile subscriber identity (“IMSI”) number received from a pre-provisioned subscriber identity module (“SIM”) component. The server accesses a national SIM manager (“NSM”) database, wherein the NSM includes pre-populated pairing of IMSI numbers with corresponding integrated circuit card identification (“ICCID”) numbers, and the server further retrieves a corresponding ICCID number for the IMSI of the mobile device and including the corresponding ICCID number with the product information.

### BACKGROUND

Prepaid mobile phones, such as “pay-as-you-go” or “prepaid wireless” or “GoPhone®” devices, describe a mobile phone for which service may be purchased by the user in advance of use. By purchasing credit in advance to use on a mobile phone network, a user can access a mobile phone network without an ongoing bill (e.g., re-occurring bill). Accordingly, a user may then use the mobile phone network until the expiration of the purchased, or prepaid, credit. In contrast to a mobile phone contract, or “post-paid” mobile phone, this alternative billing method does not require the user to enter into any long-term billing arrangement with a mobile network operator or carriage service provider (“CSP”).

A prepaid mobile customer may add more credit to the account at any time. Specifically, this may either be a credit card or debit card transaction with the provider (e.g., performed on the phone itself or via a third party such as a shop or ATM), or by purchasing additional credit at retail locations (e.g., in the form of a “refill card”). For example, a refill card may be stamped with a unique code that may be redeemed for the phone for credit. According to the current prepaid mobile packages, customers have no means of performing self-activation of the mobile device. The current activation process for these customers requires any one of a call to a customer service agent, a call to an interactive voice response unit (“IVRU”), and/or access to a website. In addition, any activation requires the customer to enter lengthy product identification numbers, etc. This user-dependent data entry is cumbersome to the customer and may lead to activation errors. With the number of prepaid mobile device customers greatly increasing, a streamlined activation process is needed.

### SUMMARY OF THE INVENTION

Described herein are systems and methods for single-step direct activation of telecommunication services for a mobile device. One embodiment of the disclosure of this application is related to a computer readable storage medium including a set of instructions that are executable by a processor. The set of instructions being operable to receive, at a server, product information from a mobile device, receive, at the server, service plan information from the mobile device, verify availability of service for the mobile device based on at least one of the product information and the service plan information activate telecommunication service with the mobile device. The product information includes an international mobile equipment identity (“IMEI”) number received from an IMEI trigger event and an international mobile subscriber identity (“IMSI”) number received from a pre-provisioned subscriber identity module (“SIM”) component. The set of instructions are further operable to accesses a national SIM manager (“NSM”) database, the NSM including pre-populated pairing of IMSI numbers with corresponding integrated circuit card identification (“ICCID”) numbers, and retrieve a corresponding ICCID number for the IMSI of the mobile device and including the corresponding ICCID number with the product information.

A further embodiment of the disclosure of this application is related to a system comprising a transceiver receiving product information from a mobile device and receiving service plan information from the mobile device, and a server verifying availability of service for the mobile device based on at least one of the product information and the service plan information, and activating telecommunication service with the mobile device. The received product information including an IMEI number received from an IMEI trigger event and an IMSI number received from a pre-provisioned SIM component. The server accesses a NSM database, wherein the NSM includes pre-populated pairing of IMSI numbers with corresponding ICCID numbers, and the server further retrieves a corresponding ICCID number for the IMSI of the mobile device and including the corresponding ICCID number with the product information.

### BRIEF DESCRIPTION OF THE DRAWINGS

FIG. 1 shows an exemplary system for direct activation of a mobile device according to an exemplary embodiment described herein.

FIG. 2 shows a detailed exemplary method for single-step direct activation of a mobile device from the perspective of a direct device activation application according to an exemplary embodiment described herein.

FIG. 3 shows a simplified method for direct activation of a mobile device from the perspective of the mobile device according to an exemplary embodiment described herein.

FIG. 4 shows a simplified method for direct activation of a mobile device from the perspective of a network server according to an exemplary embodiment described herein.

### DETAILED DESCRIPTION

The exemplary embodiments may be further understood with reference to the following description and the related appended drawings, wherein like elements are provided with the same reference numerals. The exemplary embodiments are related to systems and methods for direct activation of telecommunication services for a mobile device. Specifically, the exemplary embodiments described herein relate to systems and methods for allowing prepaid mobile phone customers to activate wireless service directly from a purchased mobile device. It should be noted that while the exemplary systems and methods may be used for activating prepaid services, additional embodiments may also apply for the activation of service for post-paid subscribers.

Currently, prepaid mobile device customers have no means of performing self-activation of their service using the purchased mobile device. According to the exemplary systems and methods described herein, self-activation, or out-of-box-provisioning (“OOBP”), of prepaid mobile service may be achieved by allowing the device, as well as the customer, to send relevant information from the device directly to the service provider. As will be described in greater detail below, direct device activation (“DDA”) may eliminate several manual entry requirements for these mobile service customers (e.g., end-users). Accordingly, DDA provides a faster and simpler self-service process for activating a prepaid mobile phone account directly from the mobile device. For example, a DDA option may be made available to prepaid packaged handsets (e.g., “Grab and Go” or “pay-as-you-go” or “prepaid wireless” or “GoPhone®” packaged devices), generally offered through national retail channels.

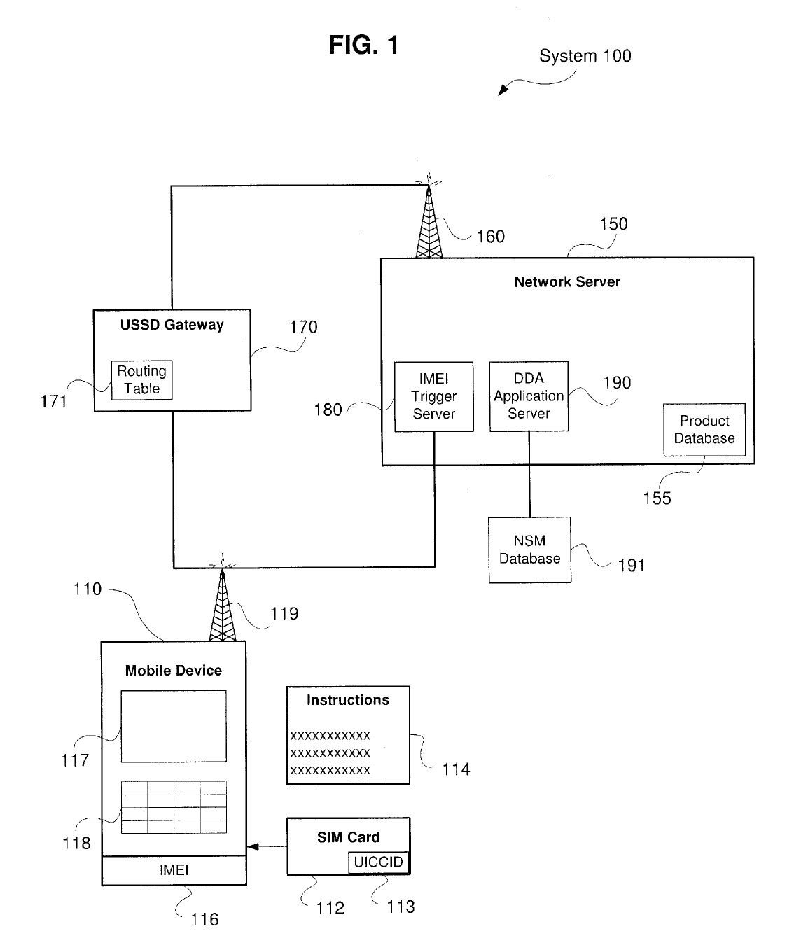

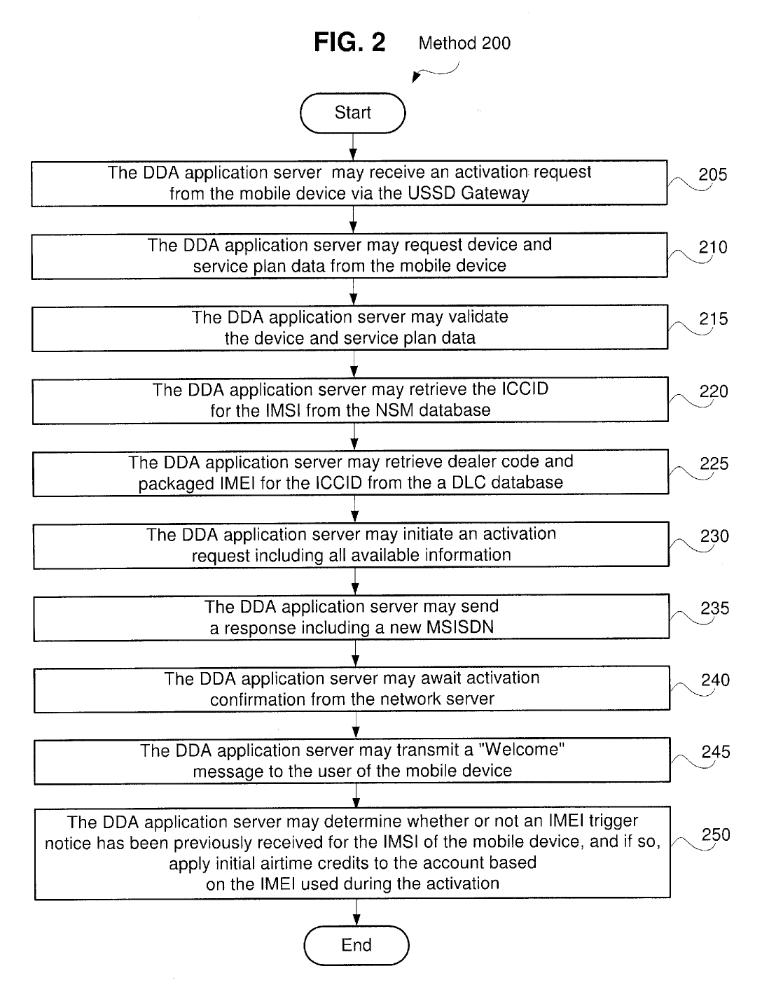

FIG. 1 shows an exemplary system 100 for direct activation of a mobile communication device 110 according to an exemplary embodiment described herein. The exemplary system 100 may include the mobile communication device 110 in communication with a network server 150, such as a network operator server or a mobility IT system of a carriage service provider (“CSP”). In addition, the system 100 may also include a DDA application server 190 for processing and communicating activation information between the mobile device 110 and the network server 150. While the DDA application server 190 is illustrated as a component within the network server 150, alternatively, the DDA application server may be a separate component within the system 100. The functions of the DDA application server 190 will be described in greater detail in FIG. 2.

The exemplary system 100 may further include an unstructured supplementary service data (“USSD”) gateway (“GW”) 170 between the device 110 and the DDA application server 190, wherein users of the device 110 may be able to activate via the USSD GW 170 directly from the device 110, itself. Accordingly, the network server 150 may communicate with the mobile device 110 via the USSD GW 170 (or USSD GW server).

The exemplary mobile communication device 110 may include a display 117 (e.g., screen), an input arrangement 118 (e.g., keypad, touch screen, etc.), and an antenna 119 (e.g., a device transceiver). In addition, the system 100 may include a server transceiver 160 attached to network server 150, wherein the server transceiver 160 and the antenna 119 allow the server 150 and the mobile device 110 to communicate over a network.

The network server 150 may receive information such as mobile device information, calling plan/rate information, usage location information, etc., from the mobile device 110.

Accordingly, the network server 150 may perform the service activation and confirmation. Additional functions of the network server 150 will be described below.

The exemplary mobile device 110 may be packaged to include a removable storage component, such as a subscriber identity module (“SIM”) card 112, and activation instructions 114. The SIM card 112 may include an integrated circuit card identification (“ICCID”) code 113 (or universal integrated circuit card identification (“UICCID”) code). Specifically, the ICCID may be stored within the SIM card 112, and may also be engraved or printed on the body of the SIM card 112. It should be noted that, alternative to the ICCID 113, the SIM card 112 may be identified by a SMART Chip serial number. Due to the fact the SIM card 112 may be pre-provisioned in the network with DDA-ready capabilities, the SIM card 112 may be referred to a “warm SIM.” In other words, a warm SIM card may be described as a SIM card that has been pre-provisioned in the Home Location Register (“HLR”) during a point in the supply chain, but prior to service activation.

The SIM card 112 may be batched with other similar SIM card having similar pre-provisioned information. Accordingly, the information included on a batch of warm SIM cards may be stored in a database, such as a National SIM Manager (“NSM”) database 191. Thus, the NSM database 191 may allow for the warm SIM card 112 to be treated as pre-provisioned components for prepaid mobile devices. For instance, a provisioning file may be created by the NSM database 191. This exemplary provisioning file may contain subscriber profile information specific to the mobile device 110. Furthermore, the provisioning file may initially limit, restrict or otherwise prevent specific mobile services, such as inbound/outbound phone calls, mobile-terminating SMS messages (or SMS-MT messages), and data usage. However, the provisioning file may allow for USSD transmission (e.g., star code dialing), as well as mobile-originating SMS messages (or SMS-MO messages) designed for the transmission of various activation information, as described below.

The mobile device 110 may include an equipment identification code 116, such as an international mobile equipment identity (“IMEI”) number or handset series number. According to the exemplary system 100, the mobile device 110 may be cellular telephone or any number of other mobile communication devices, such as for example, a portable computer, a personal digital assistant (“PDA”), a smartphone, etc.

During the activation process, the mobile device 110 may be in communication and exchange information with the network server 150 upon purchasing the device 110. According to an exemplary embodiment of the system 100, the instructions 114 may provide the user with a step-by-step process for automatically activating the mobile device 110. As noted above, the SIM card 112 and the instructions 114 may be packaged with the prepaid mobile device 110. The instructions may direct the user (e.g., service customer) to charge a battery of the device 110 and insert the SIM card 112 into the device 110 and then power up (e.g., power cycle) the device 110 in order to begin the automatic DDA process.

Upon inserting the warm SIM card 112 into the mobile device 110 and powering on the device 110, device information may be automatically transmitted to the network server 150. Specifically, information such as the subscriber identity, International Mobile Subscriber Identity (“IMSI”) number and the IMEI number may be automatically forwarded to the network server 150 for activation processing. Specifically, when the mobile device including the warm SIM card 112 is powered on, a short message service (“SMS”) message may be transmitted from the mobile device 110 to the network server 150. The SMS message may include an IMEI change notification. This IMEI change notification may be received by an IMEI trigger component, such as an IMEI trigger server 180. This notification may then be propagated to a DDA USSD application. It should be noted that the IMEI trigger server 180 may be a component within the network server 150, or, alternatively, may be a separate component within the system 100.

According to the exemplary embodiments of the system 100, the network server 150 may include a product database 155. The product database 155 may allow the network server 150 to identify a product type of the mobile device 120 via the IMEI and ICCID information.

The DDA application 190 may subscribe to the IMEI trigger server 180 in order to receive IMEI notification in real-time. Furthermore, the DDA application 190 may interface with the IMEI trigger server 180 to validate the IMEI used during the activation of the device 110.

The functions of the USSD GW 170 may be deployed in a Network Identity Register (“NIR”) as a separate application than the regular Home Location Register (“HLR”). The HLR may be defined as a network element that acts as a home repository for service subscriber accounts. The HLR may include customer profiles, customer access privileges, etc. According to the exemplary system 100, the USSD GW 170 may parse the content of a USSD message received from a user (e.g., the content within the fields between the “*” characters). This content may include activation codes, plan selections, language selection, ZIP code information, etc. For example, an exemplary activation code may be *123 for a pay-as-you-go (“PAYG”) plan in English, *321 for a PAYG plan in Spanish, *456 for a pick-your-plan (“PYP”) plan in English, *654 for a PYP plan in Spanish, etc. Furthermore, additional information, such as rate plan information and ZIP code information, may be added to the USSD dial string (e.g., *123*ZIP*rateplan#).

This USSD dial string may be sent to the NIR as an USSD message, wherein it is routed to the USSD GW 170 to be parsed. The parsed content of the USSD message may be placed into a Simple Object Access Protocol/Extensible Markup Language (“SOAP/XML”) document, and then embedded into the body of a Hypertext Transfer Protocol (“HTTP”) request message. Responses from a USSD application may also be in the form of a SOAP/XML document, in which it may be sent in the body of an HTTP response message. Connectivity for this interface may be from the NIR hosting the USSD GW 170.

The USSD GW 170 may then route the message to a USSD application based on the * code and the subsequent digits included in the USSD message, if necessary. The USSD GW 170 may include a configurable USSD application routing table 171 in which any relevant routing information, as well as several other configurations related to each USSD application, may be configured. The USSD GW 170 may use the USSD application routing table 171 while performing a mobile-initiated transaction. Specifically, the routing table 171 may be used to determine a destination of the USSD message, as well as a suitable transport network for routing. For example, the routing table 171 may include routing information for sending the IMSI of the mobile device 110 to the network server 150.

The exemplary USSD GW 170 of the system 100 may include a plurality of applications (e.g., USSD applications). The USSD GW 170 may generate log files for events, such as the receipt of a USSD message from a use of the mobile device 110. The USSD GW 170 may also monitor the correspondence between the mobile device 110 and the network server 150 while reporting any errors in communication (e.g., by generating error reports).

The conventional mobile service activation process for prepaid customers requires a call to customer service, a manual entry of lengthy IMEI/ICCID values, ZIP code data, rate plan data, etc. This process is cumbersome and error prone. However, as will be described below in the exemplary methods 200-400, the user (e.g., mobile service subscriber) may now initiate self-activation by dialing a concatenated dial string. This dial string may include information such as an activation code (e.g., an unstructured supplementary service data (“USSD”) activation code), usage location information (e.g. a ZIP code), rate plan information (e.g., a calling plan code), etc. The USSD may be described as signaling channel transport mechanism similar to data, or short message service (“SMS”). Accordingly, this exemplary system 100 eliminates the need for customer service interaction, use of an IVRU system, and use of any web-based services for the activation of the mobile device 110.

FIG. 2 shows a detailed exemplary method 200 for single-step direct activation of a mobile device from the perspective of a direct device activation (“DDA”) application server 190 according to an exemplary embodiment described herein.

In step 205, the DDA application server 190 may receive an activation request from the mobile device 110 via the USSD GW 170. Specifically, upon activation of the mobile device 110, the DDA application server 190 may receive IMEI information (e.g., a handset series number) from the mobile device 110 in a SOAP/XML document. For instance, the IMEI information may be transmitted by the warm SIM card 112 of the mobile device 110 to the IMEI trigger server 180. The IMEI trigger server 180 may provide the DDA application server 190 with the IMEI information.

In step 210, the DDA application server 190 may request device and service plan data from the mobile device 110. The mobile device 110 may allow for the customer to enter service data in the form of a USSD message. Specifically, the customer may enter a star codes (or USSD dial string) specific to different plan types, language settings, ZIP code, etc. in order to initiate USSD activation. The content of the USSD message may be parsed by the USSD GW 170, and then referenced against the routing table 171. Based on the routing table 171, the USSD GW 170 may provide the DDA application server 190 with the IMSI of the mobile device 110.

In step 215, the DDA application server 190 may validate the device and service plan data. Specifically, the DDA application server 190 may determine if the requested rate plan is valid; if the ZIP code is valid; and if the requested rate plan is serviced in the ZIP code (e.g., verify availability of service in the received ZIP code). In addition, the DDA application server 190 may validate the IMEI used during the activation process against the packaged IMEI, included with the mobile device 110. Furthermore, the DDA application server 190 may also determine if any credit should be applied to prepaid account after the activation.

In step 220, the DDA application server 190 may retrieve the ICCID for the IMSI from the NSM database 191. Specifically, the USSD GW 170 may request IMSI from NIR for a given pseudo-MSISDN (e.g., temporary MSISDN) and transmit the IMSI to the DDA application server 190. After receiving the IMSI from the USSD GW 170, the DDA application may then obtain the ICCID from NSM database 191 for that specific IMSI.

In step 225, the DDA application server 190 may retrieve dealer code and packaged IMEI for the ICCID from a device life cycle (“DLC”) database. Specifically, the DDA application server 190 may queries the DLC in order to obtain a purchased-IMEI. Accordingly, if IMEI trigger information is available for that specific IMSI, the DDA application 190 may use the IMEI used during the activation process.

In step 230, the DDA application server 190 may initiate an activation request including all available information (e.g., device data, service plan data, etc.), and obtain a new MSISDN. Therefore, the subscriber account may be activated within a billing system.

In step 235, the DDA application server 190 may send a response including a new MSISDN. In step 240, the DDA application server 190 may await activation confirmation from the network server 150. During this process, the DDA application server 190 may notify the customer via the USSD GW 170 to power cycle the mobile device 110. Furthermore, the DDA application server 190 may provide the customer with the new MSISDN information, if it is available (e.g., received in time).

In step 245, the DDA application server 190 may transmit a “Welcome” message to the user of the mobile device 110. For instances, the SMS message may include a “welcome” message, a mobile number for the device 110, a rate plan and feature package selection, account/balance information, initial airtime credit, account expiration date, passcode information, automated assistance contact (e.g., “Dial 611”), refill instructions based on product, feature package options based on product, further purchasing instructions, etc. Accordingly, the DDA process of the mobile device 110 may be completed. The user may now operate the prepaid mobile device 110 according to the selected rate and features. It should be noted that step 245 may terminate the activation session from the perspective of customer interaction.

In step 250, the DDA application server 190 may determine whether or not an IMEI trigger notice has been previously received for the IMSI of the mobile device 110. If it is received, and if the IMEI used during activation matches the IMEI packaged then the initial airtime credit may be applied to the account.

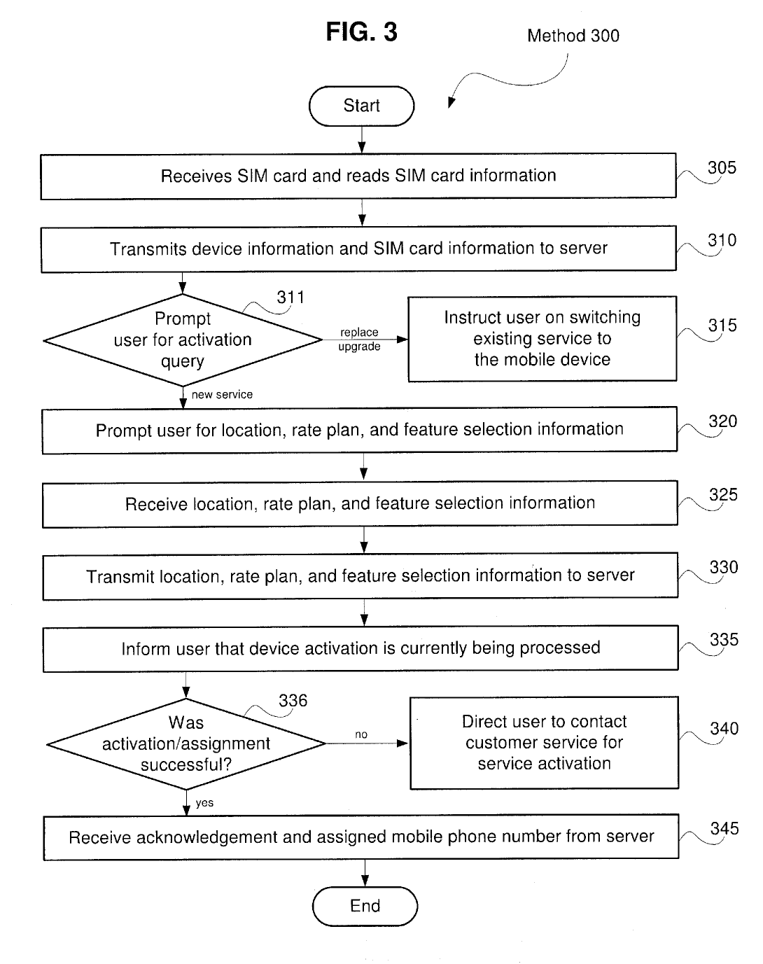

FIG. 3 shows a simplified method 300 for direct activation of the mobile device 110 from the perspective of the mobile device 110 according to an exemplary embodiment described herein. The method 300 will be discussed with reference to the exemplary components of the system 100 of FIG. 1. It should be noted that any communication between the mobile device 110 and the user may be accomplished via a text message displayed on the mobile device 110, an audio instruction from the mobile device 110, or any combination of visual and/or audio instructions.

In step 305, the mobile device 110 may receive and read the SIM card 112. As noted above, the SIM card 112 may be packaged with the prepaid mobile device 110 and inserted into the device 110 by the user. Upon the user powering on the mobile device 110, the ICCID information 113 may then be read from the SIM card 112. As noted above, the SIM card 112 may also be identified by a SMART Chip serial number.

In step 310, the mobile device 110 may transmit device information and information read from the SIM card 112 to the network server 150. According to the exemplary embodiment of the method 300, this step 310 may be performed without any interaction with the user. Specifically, once the user powers on the mobile device 110 and the SIM card 112 information is read, the mobile device 110 may transmit information to the network server 150 automatically. This information may include the IMEI code of the mobile device 110, as well as the subscriber identity and IMSI code 113 of the SIM card 112. When subscriber dials the activation code (e.g., *123 . . . ), the device may send USSD message to the network server 150. The USSD GW may send the activation info to the network server 150. Accordingly, the network server 150 may then determine the product and service to be activated. If the network server 150 is unable to determine the product based on the IMEI and ICCID information, the mobile device 110 may instruct the user to select a product from a product list, or instruct the user to call customer support.

In step 315, the mobile device 110 may prompt the user with an initial activation query. Specifically, the mobile device 110 may receive the initial activation query from the network server 150 and display the query to the user. For instance, the query may ask the user as to the purpose of the newly purchased prepaid mobile device 110. Examples may include: activating new service with the mobile device 110; upgrading existing service; replacing a lost/stolen device with existing service; etc. If the response to the query is to activate new service, the method 300 may advance to step 320. If the customer indicates either upgrade existing service or device replacement, then in step 316, the mobile device 110 may instruct the user how to complete the process, such as switching existing service to a new device (e.g., placing an existing SIM card within the new mobile device 110).

In step 320, the mobile device 110 may prompt the user for location information, rate plan selection, and plan feature selection. The location information may be the ZIP code from where the user will use the mobile service most. The rate plan selection may include information describing the type and level mobile service requested. It should be noted that the availability of certain rate plan may be dependent on the ZIP code provided by the user. The plan feature selection may include information relating to specific features available to the user. It should be noted that the availability of certain features may be dependent on the rate plan selected by the user. For instance, the feature selection option may be limited to certain plans, such as a pick you plan (“PYP”) service. Furthermore, features options may be made available to pay as you go (“PAYG”) plans.

In step 325, the mobile device 110 may receive location, rate plan, and feature information from the user. In step 330, the mobile device 110 may transmit location, rate plan, and feature information to the network server 150. Specifically, the mobile device 110 may transmit the ZIP code, plan selection, and feature selection to the network server 150 to provision the activation and mobile number assignment process.

In step 335, the mobile device 110 may inform the user that the device activation is currently being processed. During the provisioning process, the user may receive a message from the mobile device 110 to wait for the activation process to be completed. For example, the mobile device 110 may display a message such as, “Wait one moment while we process your new mobile number.”

In step 340, the mobile device 110 may determine if activation and/or assignment of a mobile number was successful. If the activation and number assignment were successful, the method 300 may advance to step 340. If the activation and number assignment were unsuccessful, the method 300 may advance to step 385. In step 341, the mobile device 110 may transmit a message to the user directing the user to contact the service provider (e.g., customer care/support) for assistance. For instance, the mobile device 110 may display the message while providing an appropriate telephone number to reach customer support. Accordingly, this number may be selected and dialed via the mobile device 110 in order to initiate service activation via customer support.

In step 345, the mobile device 110 may receive an acknowledgment and an assigned mobile number from the network server 150. The mobile device 110 may then transmit the acknowledgement and new mobile number to the user, along with any finalization instructions. For example, the finalization instructions may include instructions to “power-cycle” the mobile device 110 (e.g., requesting the user to deactivate and reactivate the power to the mobile device 110). The user may be informed that in order to finalize the activation process, the user should power cycle the mobile device 110 for a specified time period (e.g., 10 minutes). Once the device is turned back on, the mobile service may be activated.

In addition, the finalization instructions may also include providing the user with a SMS message providing details of the activation, as well as usage information. As noted in the method 200 of FIG. 2, the SMS message may include a “welcome” message, a mobile number for the device 110, a rate plan and feature package selection, account/balance information, initial airtime credit, account expiration date, passcode information, automated assistance contact (e.g., “Dial 611”), refill instructions based on product, feature package options based on product, further purchasing instructions, etc.

Accordingly, the DDA process of the mobile device 110 may be completed. The user may now operate the prepaid mobile device 110 according to the selected rate and features.

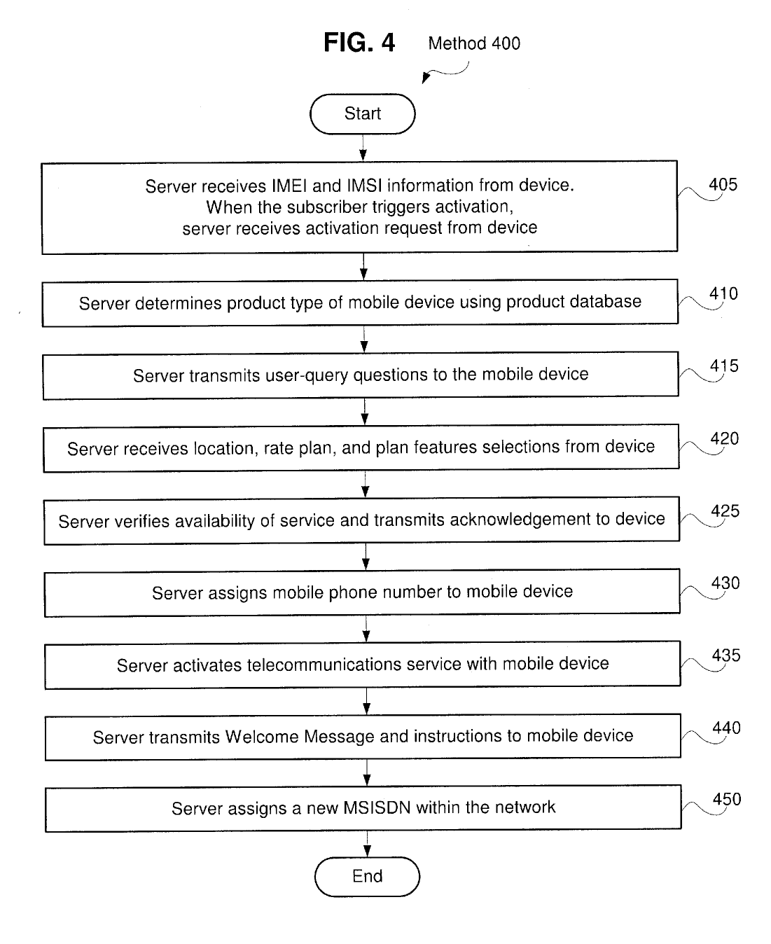

FIG. 4 shows a simplified method 400 for direct activation of the mobile device 110 from the perspective of a network server 150 according to an exemplary embodiment described herein. The method 300 will be discussed with reference to the exemplary components of the system 100 of FIG. 1.

In step 405, the network server 150 may receive IMEI and IMSI information from the mobile device 110. When the subscriber triggers activation, the network server 150 may receive an activation request from the mobile device 110. As noted above, pre-provisioned DDA-ready SIM cards may trigger the activation process of the mobile device 110. In other words, once the user installs the SIM card 112 in the mobile device 110, the mobile device 110 may automatically transmit device and SIM card information, such as the IMEI and IMSI information. When the user initiates the activation by dialing activation code, the network server may receive the activation request from device.

In step 410, the network server 150 may determine a product type of the mobile device 110 based upon referencing the product database 155. If the network server 150 is unable to identify the product, the network server 150 may instruct the mobile device 110 to prompt the user for product information. Once the product information has been identified, by either referencing the database 155 or contacting the user, the method 400 may advance to step 415.

In step 415, the network server 150 may transmit user query questions to the mobile device 110. As noted in method 300, the mobile device 110 may query the user as to the purpose of the newly purchased mobile device 110. If the mobile device 110 was purchased to activate new service, the method 400 may advance to step 420. It should be noted that this step may be performed directly at the mobile device 110. In other words, these user query questions may be preloaded on the mobile device 110. In this case, the step 415 may be omitted at the network server 150.

In step 420, the network server 150 may receive location, rate plan, and plan feature information from the mobile device 110. According to an exemplary embodiment of the method 400, the user may enter a concatenated USSD dial string using specialized USSD codes for activation of service. For example, the entire dial string may start with the specific USSD code and include the user's ZIP code and rate plan selection (e.g., “*123*ZIP CODE*RATE PLAN #*”). As noted above, the user may enter the ZIP code from where the mobile device 110 while be used the most. The rate plan number may relate to a specified plan offered by the service provided for the mobile device product.

In step 425, the network server 150 may transmit an acknowledgement to the mobile device 110. Specifically, the network server 150 may verify the availability of the selected service and/or selected features in the specified ZIP code. Once the service has been verified, the acknowledgment may be sent to the mobile device 110. If the network server 150 is unable to verify the selected service/features, the network server 150 may transmit an error message to the mobile device 110. This error message may instruction the user to contact customer service for device activation.

In step 430, the network server 150 may assign a telephone number to the mobile device 110. In step 435, the network server 150 may activate telecommunication service with the mobile device 110. It should be noted that the DDA process may include loading of initial airtime credits if included with the selected service. In step 440, the network server 150 may transmit a welcome message to the mobile device 110. This message may inform the user of the new mobile number and inform to power cycle the mobile device 110 in order to activate service. Similar to the step 415, the welcome message may be preloaded on the mobile device 110. In this case, the step 440 may be omitted at the network server 150.

When the activation is completed in the network server 150, in step 445, a new Mobile Subscriber Integrated Services Digital Network Number (“MSISDN”) may be assigned within the network and the user may be provisioned in the appropriate regional real HLR. Accordingly, routing tables (e.g., G-Flex routing) may be updates and provisioning of other network elements may also be processed in order to complete the activation of the mobile device 110 within the exemplary network.

The systems and methods described above may provide a competitive advantage to providers of prepaid mobile devices. The exemplary DDA systems and methods automatically collect device and service information from the mobile device 110 and pre-populated databases while eliminating these manual entry requirements from the user-end. Accordingly, these embodiments may reduce activation failures due to errors, increase sales-to-activation conversion rates, reducing activation-based customer support costs/demand, reduce operational and transaction cost for self-service activation, etc. Thus, the DDA systems and methods may increase overall customer satisfaction with prepaid packaged mobile device service through offering a fast and simple process for activating new service while minimizing activation failures.

It should be noted that, according to alternative embodiments of the DDA systems and methods described herein, the mobile device 110 may utilize an interactive menu for collecting information from the subscriber. For instances, the mobile device 110 may display a menu prompting the user for subscriber information, such as activation codes, plan selections, language selection, ZIP code information, etc. Once the mobile device 110 receives the subscriber information, the mobile device 110 may transmit the information to the network server 150. For instance, the mobile device 110 may generate a USSD message based on the user's responses to the menu prompt. Therefore, as opposed to the user entering the USSD dial string, the mobile phone 110 may create the USSD dial string (e.g., *123*ZIP*rateplan#).

It should be noted that the DDA systems and methods may be designed to work both on-network and off-network, such as domestic off-network locations (e.g., Puerto Rico market). Off-network service may be specific to a particular coverage area and/or specific for each product (e.g., PYP coverage may be different from PAYG coverage). Furthermore, the exemplary systems and methods may allow for the ability to add additional coverage areas.

It will be apparent to those skilled in the art that various modifications may be made in the described embodiments, without departing from the spirit or the scope of the application. Thus, it is intended that the present disclosure covers modifications and variations of this application provided they come within the scope of the appended claimed and their equivalents.

1. A non-transitory computer readable storage medium including a set of instructions that are executable by a processor, the set of instructions being operable to:
receive, at a server, product information from a mobile device, wherein the received product information is automatically transmitted from the mobile device upon initial powering by the mobile device of a component including the product information;
receive, at the server, service plan information from the mobile device;
verify availability of service for the mobile device based on at least one of the product information and the service plan information; and
activate telecommunication service with the mobile device.

2. The computer readable storage medium according to claim 1, wherein the product information includes:
an international mobile equipment identity (“IMEI”) number received from an IMEI trigger event; and
an international mobile subscriber identity (“IMSI”) number received from a pre-provisioned subscriber identity module (“SIM”) component.

3. The computer readable storage medium according to claim 2, wherein the set of instructions are further operable to:
access a national SIM manager (“NSM”) database, the NSM including pre-populated pairing of IMSI numbers with corresponding integrated circuit card identification (“ICCID”) numbers; and
retrieve a corresponding ICCID number for the IMSI of the mobile device and including the corresponding ICCID number with the product information.

4. The computer readable storage medium according to claim 2, wherein the component is the pre-provisioned SIM component which limits the telecommunication service of the mobile device until activation.

5. The computer readable storage medium according to claim 1, wherein the set of instructions are further operable to:
assign a telephone number to the mobile device; and
transmit the telephone number to the mobile device.

6. The computer readable storage medium according to claim 1, wherein the service information includes at least one of a location, a selected rate plan, and a selected service feature.

7. The computer readable storage medium according to claim 1, wherein the service information is received via an unstructured supplementary service data (“USSD”) message.

8. The computer readable storage medium according to claim 1, wherein the mobile device is activated for prepaid telecommunication services.

9. The computer readable storage medium according to claim 1, wherein the mobile device is activated for post-paid telecommunication services.

10. The computer readable storage medium according to claim 1, wherein the set of instructions are further operable to:
detect an unsuccessful activation of the telecommunication service; and
transmit an error message to the mobile device.

11. A system, comprising:
a transceiver receiving product information from a mobile device and receiving service plan information from the mobile device, wherein the received product information is automatically transmitted from the mobile device upon initial powering by the mobile device of a component including the product information; and
a server verifying availability of service for the mobile device based on at least one of the product information and the service plan information, and activating telecommunication service with the mobile device.

12. The system according to claim 11, wherein the product information includes:
an international mobile equipment identity (“IMEI”) number received from an IMEI trigger event; and
an international mobile subscriber identity (“IMSI”) number received from a pre-provisioned subscriber identity module (“SIM”) component.

13. The system according to claim 12, wherein the server accesses a national SIM manager (“NSM”) database, the NSM including pre-populated pairing of IMSI numbers with corresponding integrated circuit card identification (“ICCID”) numbers, and the server retrieves a corresponding ICCID number for the IMSI of the mobile device and including the corresponding ICCID number with the product information.

14. The system according to claim 12, wherein the component is a pre-provisioned subscriber identity module (“SIM”) component which limits the telecommunication service of the mobile device until activation.

15. The system according to claim 11, wherein the server assigns a telephone number to the mobile device, and wherein the transceiver transmits the telephone number to the mobile device.

16. The system according to claim 11, wherein the service information includes at least one of a location, a selected rate plan, and a selected service feature.

17. The system according to claim 11, wherein the service information is received via an unstructured supplementary service data (“USSD”) message.

18. The system according to claim 11, wherein the mobile device is activated for prepaid telecommunication services.

19. The system according to claim 11, wherein the mobile device is activated for post-paid telecommunication services.

20. The system according to claim 11, wherein the server detects an unsuccessful activation of the telecommunication service, and wherein the transceiver transmits an error message to the mobile device.
